(19) United States
(12) Patent Application Publication
(10) Pub. No.: US 2009/0215664 A1
(43) Pub. Date: Aug. 27, 2009

(54) Melt Granules for Detergents and Cleaning Agents

(75) Inventor: Wilfried Raehse, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/392,368

(22) Filed: Feb. 25, 2009

Related U.S. Application Data
(63) Continuation of application No. PCT/EP2007/058479, filed on Aug. 16, 2007.

(30) Foreign Application Priority Data
Aug. 28, 2006 (DE) 10 2006 040 103.4

(51) Int. Cl. C11D 17/06

(52) U.S. Cl. 510/276; 510/445

(57) ABSTRACT

Melt granules for detergents and cleaning agents, obtained by certain melting-solidification methods. The melt granules make possible dust-free, abrasion-resistant solid detergents and cleaning agents. The melt granules can also be used for scenting purposes. The production methods described offer many possibilities for influencing the product aesthetics.

### CROSS-REFERENCE TO RELATED APPLICATIONS

This application is a continuation under 35 U.S.C. §§ 120 and 365(c) of International Application PCT/EP2007/058479, filed on Aug. 16, 2007. This application also claims priority under 35 U.S.C. § 119 of DE 10 2006 040 103.4, filed on Aug. 28, 2006. The disclosures of PCT/EP2007/058479 and DE 10 2006 040 103.4 are incorporated herein by reference in their entirety.

### BACKGROUND OF THE INVENTION

The present invention relates to a method for producing melt granules for detergents and cleaning agents. It also relates to certain melt granules as well as their use for washing laundry and for scent purposes.

Solid detergents and cleaning agents have been welcome aids in the household and industry for many years and are used by almost everyone as a matter of course.

One important problem in the design of solid detergents and cleaning agents lies mainly in providing such agents that are essentially dust-free and abrasion-resistant. This is important not only for the aesthetic perception of the user, but also for practical use. Separation of the solid detergent and cleaning agent may occur all too easily as a result of abrasion and dust segregation and may, for example, lead to individual batches of detergent that should actually have the same content but nevertheless differ from one another due to separation and therefore promote washing results of varying qualities, which can disappoint the consumer.

### DETAILED DESCRIPTION OF THE INVENTION

The object of the present invention was therefore to provide a dust-free and abrasion-resistant solid detergent or cleaning agent.

The present object is achieved by the subject of the invention. This is formed by a method for producing solid, water-free detergents or cleaning agents or components for them containing nonionic surfactants in the form of melt granules, characterized in that
(a) at least one detergent or cleaning agent ingredient that is solid at room temperature (i.e., 20° C.), preferably comprising a surfactant or surfactant mixture or a precursor thereof is melted,
(b) the melt is mixed with at least one other solid detergent or cleaning agent ingredient and/or at least one liquid,
(c) the mixture from (b) is solidified by cooling.

Water-free in the context of this invention means that the resulting melt granules have a free water content of <5 wt %, preferably <2 wt %, in particular <1 wt %, based on the total melt granules.

Free water is water that is not present in chemically and/or physically bound form. Free water thus does not include water bound to the zeolite, for example.

The subject of the invention thus allows preparation of a dust-free, abrasion-resistant, solid, water-free detergent that can combine the advantages of a liquid detergent (a high surfactant content, good cleaning power on synthetic fibers and fat-based soiling at T<60° C.; being gentle on fabrics) with the advantages of solid detergents (e.g. high builder content).

With the present invention, it is possible to provide especially aesthetic detergents that differ significantly from conventional powders and may be offered, for example, in powder form, as beads, flakes, strips, pastilles, micropastilles and thus allow a great variation in product design. For example, design in any desired shapes is possible by casting or pressing in negative molds, including, e.g. application of company logos, letters, characters or other symbols.

Due to the incorporation of solids or liquids into the melt, an improved stability in storage is the result, because oxygen cannot come in contact with the enclosed ingredients. In particular a perfume that may be used is then embedded in protected form in the melt granules without any possibility of contact with bleach that may be present in added granules. For example, a controlled-release effect may be achieved, e.g. by embedding only TAED or a long-lasting perfume or a fabric softening component into melt granules. These components may then be released from the granules after a delay. The dissolving rates of the melt granules can easily be adjusted as a function of the temperature by selecting the substances forming the melt, e.g. their composition, chain length and distribution as well as the degree of ethoxylation in the case of nonionic surfactants.

According to a preferred embodiment of the invention, the mixture is first cast in any mold in step (c) in the method, then solidified and preferably next unmolded. The negative molds are preferably on a cooled belt running continuously or a on roller and/or a double roller. With suitable formulation of the recipe, unmolding aids may be omitted and then the molded product will drop directly out of the mold by gravity after cooling suitably. The outer shape of the resulting product is defined during the solidification process. The molds may be selected so that the products are supplied to the consumer directly in the mold.

There are no limits for those skilled in the art in the choice of casting molds; in addition to traditional molds made of metals and/or plastic, molds like sand molds may also be used. Suitable parting agents (for example, starch or powdered beeswax, pyrogenic silicates, zeolites, finely divided carbonates, etc.) are spread out in a bed for this purpose. Recesses may be impressed into the bed using a positive stamp, forming the molds after the stamp is raised. The melt may be metered into these recesses in a process completely similar to traditional molding. The molds may then be separated from the moldings by screening, for example. However, it is also possible to use the powder matrix to form a sheathing that surrounds the molding entirely or partially. To do so, the moldings may be heated at the surface after solidifying in the powder matrix, so that the ingredients of the powder matrix which are in direct contact with the molding are partially dissolved and/or stuck to the molding. Complete sheathings can be achieved in this way when the moldings in the powder bed are covered with another powder layer.

Alternatively, in the production of the products, the use of molds may also be omitted. Methods are available here, with which the melts are processed and shaped without an external mold, e.g. by pelletizing, prilling, pastilling and flaking by means of cooling rollers. Suitable inventive methods also include extrusion methods (e.g. “noodle extrusion” with all shapes), roller compacting with/without negative molds or dripping of the melt.

According to another preferred embodiment of the invention, the mixture from step (b) of the method (i.e., the melt with at least one additional solid detergent or cleaning agent ingredient and/or at least one liquid) is dripped to create beads in step (c) or is sprayed to produce powders.

According to another preferred embodiment of the invention, the mixture from step (b) of the method (i.e., the melt with at least one additional solid detergent or cleaning agent ingredient and/or at least one liquid) is pastilled, flaked or converted to strips in step (c) by cooling on a steel roller or a steel belt.

The method of prilling comprises the production of granular bodies of meltable substances, whereby in this inventive variant of the method, the melt is sprayed in a defined droplet size at the tip of a tower, solidified in free fall, preferably through a (cold) gas stream and the prills are obtained as granules at the bottom of the tower.

Drip methods lead to spherical granules with particle sizes in the range d₅₀ of advantageously 0.4 to 5 mm, preferably 0.8 to 1.5 mm, adjustable through the drip nozzles (d₅₀ is the median value, which is defined as the particle size above and below which 50% of the quantity of particles occur). The melt droplets solidify in free fall over several meters through a cold gas stream which may be brought to lower temperatures with liquid air/nitrogen/CO₂ or a refrigeration system.

In general, all gases may be used as the (cold) gas stream, such that the temperature of the gas should be significantly below the solidification temperature of the melt. To avoid long falling distances, it is possible to work with more intensely cooled gases, e.g. with (deep) cooled air or, if necessary, even with liquid nitrogen, which is sprayed into the gas stream of the spraying towers or the falling zones in drip systems.

The grain size of the resulting prills can be varied through the choice of the spray nozzles and the process conditions, but particle sizes d₅₀ that are easily implemented technically are in the range of 0.05 to 2 mm, preferably d₅₀ of 0.3 to 0.7 mm, for example.

An alternative method for prilling consists of pastilling. Pastilling comprises dosing the melt onto steel belts that are at a temperature below the solidification temperature of the belt and are cooled from underneath.

Pastilling may supply small particles (micropastilling) as well as larger particles having sizes between 0.2 and 10 mm, preferably between 1 and 6 mm, for example, in conventional industrial methods. It is also possible to apply extremely thin strips with a thickness of ≦1 mm, preferably <0.5 mm, in particular <0.25 mm and especially preferably <0.15 mm, which can be converted to wafers (length and width in the range of 0.5 to 30 mm, preferably 1 to 10 mm, in particular from 2 to 6 mm, for example) by breaking.

The use of cooling rollers is suggested as a less expensive variant. To do so, the melt is applied to a cooling roller or sprayed, the solidified portions are scraped off and pulverized if necessary.

The use of cooling rollers allows problem-free adjustment of the desired particle size range d₅₀, which in this inventive method may also be less than 1 mm, e.g. d₅₀ of 200 to 700 μm, for example.

The inventive method can be performed especially preferably by producing pellets with a spherical shape, preferably having diameters of 0.4 to 5 mm, especially preferably from 0.7 to 4 mm and in particular from 1 to 3 mm. To do so, inventive process variants in which the melt is introduced into a cooling stream of a gaseous or liquid coolant, solidified in the cooling stream, forming pellets, and then removed from the cooling stream are preferred.

In one process variant, the melt, which is preferably a liquid to pasty composition, is introduced into a cooling stream of a liquid coolant (e.g. liquid air), and solidifies in the cooling stream, forming pellets and then removed from the cooling stream. To do so, the melt may be dripped through a dripping device (e.g. hollow needles) into an inclined flow chute that is open at the top and in which a laminar flow of liquid coolant is flowing. The droplets are solidified in the coolant stream in the flow chute, forming pellets, and are then supplied to a perforated or grid-shaped conveyor belt, for example. Coolant flows out through the openings while the pellets solidify completely on the conveyor belt at the latest and are conveyed to a collecting tank.

The pellets are introduced into a stream of liquid coolant at least proportionally for solidification before they reach the conveyor belt. The resulting strength depends on the dwell time of the pellets on the flow chute and therefore on its length, among other things. To also be able to ensure adequate dwell times of the pellets on the flow chute with variable thermal capacities and volumes of the solidifying melt, their length must be dimensioned generously.

An even simpler and less expensive process variant for reproducible production of pellets in which the risk of deformation is reduced and which is more compact for performing the method provides for the cooling stream to be created through directed forced flow in a coolant bath.

In this process variant, the cooling stream is created in a coolant bath. The pellets are solidified entirely or partially in the cooling stream. This avoids mechanical contacts between the solidifying pellets and a wall at a point in time when the pellets do not yet have adequate surface hardness and strength. Therefore, unwanted and unreproducible changes in the surfaces of the pellets are ruled out.

A large cooling volume is available through the coolant bath. The pellets solidify rapidly at least at the surface due to the cold and are therefore rapidly stabilized mechanically. They may therefore be conveyed away in a high pellet density and accordingly conveyed rapidly away from a drip area, where they are introduced into the coolant without any fear of deformation or sticking due to contact among them. The high pellet density allows a short cooling zone to this extent and thus allows a compact design of the equipment required for this. The cooling stream is created by directed forced flow of the coolant in the coolant bath. The cooling stream runs, for example, in a straight line or in a circle within the coolant bath. With the help of the directed flow, the pellets are conveyed between a defined charging station where the melt is introduced into the cooling stream and a defined discharge station, where the pellets are removed from the cooling stream, so that the dwell time of the pellets in the cooling stream can be adjusted in a reproducible manner. Any fluctuations in mass and density of the pellets, such as those manifested, e.g. in free fall or in buoyancy in a cooling liquid are therefore less noticeable.

A horizontal cooling stream is preferably created. A horizontal forced flow in the cooling bath can be implemented comparatively easily. In this regard, it has proven advantageous in particular to create a cooling stream through directed surface flow in the coolant bath.

To create the cooling stream, use of a liquid pump has proven successful. Liquid coolant is moved in the coolant bath by means of the liquid pump by suction and pressure, thereby creating the cooling stream. The weight of forced flow is variably adjustable by means of the liquid pump.

A procedure in which the pellets are solidified at least partially in the cooling stream and are discharged from the cooling stream by means of a conveyor device and are then completely solidified on the conveyor device under the action of a gaseous coolant, e.g. air has proven to be especially favorable. The pellets here are solidified in the liquid coolant stream only to the extent that they can be conveyed out of the coolant bath without any mechanical damage.

Next the pellets are completely solidified by the action of the gaseous coolant, for which the cold exhaust air of the liquid coolant is also suitable. Exhaust air here is preferably understood to be the exhaust gas of the liquid coolant which develops during operation. By utilizing this for complete solidification of the pellets, this type of process proves to be especially cost-saving. A cooling stream which is directed at the conveyor device is expedient. Corresponding inventive methods in which the pellets are solidified proportionately in the cooling stream, discharged from the cooling stream by means of a conveyor device and completely solidified on the conveyor device under the influence of a gaseous coolant, the cold exhaust air of the liquid coolant preferably being used as the gaseous coolant, are especially preferred.

A further improvement in this procedure is obtained by the fact that a cooling gas stream is created by directed forced flow in the gaseous coolant, such that the cooling gas stream is directed parallel to the direction of conveyance of the conveyor device. A defined and reproducible cooling of the pellets is achieved due to the fact that the gaseous coolant, e.g. the exhaust air of the coolant bath is moved in cocurrent or in countercurrent to the conveyor device. The cooling gas stream is created with the help of a gas exhaust device.

In performing this inventive process variant, a directed cooling stream is created by means of a liquid pump in the coolant bath. By means of the liquid pump, coolant is drawn in at the coolant intake opening and is discharged from the coolant outlet as a horizontal cooling stream near the surface. Above the cooling stream, a drip device is provided by means of which the melt is dripped into the cooling stream and entrained by it. The melt is dripped into the coolant stream and carried along by it to the transfer area. The average velocity of flow of the cooling stream along this segment is 0.2 m/s and the segment length amounts to approximately 100 cm. This yields an average dwell time of the beads of melt dripped into the liquid cooling stream of approximately 5 seconds. This treatment leads to at least a superficial solidification of the beads, whose mass amounts to approximately 0.1 g with a diameter of approximately 6 mm each. Due to the fact that the at least superficial solidification in the coolant bath proceeds very rapidly and without any contact with the walls, it is possible to remove the beads at a high speed and density from the drip area without any fear of mechanical damage to the beads.

A conveyor belt runs below the cooling stream and on a first partial segment approximately parallel to it, discharging the at least superficially solidified beads from the coolant bath. To do so, the conveyor belt is removed from the coolant bath obliquely upward into a channel-like outlet of the housing along a second partial segment. The cooling stream conveying the beads is directed out of the coolant bath to the transfer area of the conveyor belt. While the beads are conveyed on the conveyor belt through the channel-like outlet to the collecting tank, they solidify completely. To this end, the exhaust air above the conveyor belt is drawn in cocurrent with the direction of conveyance of the beads. The exhaust air continues to withdraw energy from the beads in its flow along this segment of path and heats up in the process.

The belt length and speed of the conveyor belt are selected here, so that the dwell time of the beads on the belt amounts to approximately 30 seconds, so they are completely solidified at the end of the channel-like outlet.

The beads produced according to the invention are held on the conveyor belt in the channel-like outlet and are conveyed into a collecting tank.

Another possibility for processing the melt in a manner that shapes it without using an external mold consists of precooling the corresponding compositions, so that pasty or gelatinous compounds are the result. These compounds can then be processed in a known manner to yield moldings, e.g. by extrusion. This method is also available for production of round particles by extruding precooled compounds, cutting them into pieces and then sending them to a rounding unit.

It is readily possible to blend the inventively produced pellets with other components, as is customary in the traditional powder technology for detergents, cleaning and dishwashing agents. The inventively produced beads may be blended not only with other produced inventively produced beads of a different composition but also with particulate solids, granules, extrudates, flakes, etc. In this way, detergents or cleaning agents of all types can be produced.

The detergent or cleaning agent ingredient which is solid at room temperature and is melted in a first process step according to the invention is preferably a surfactant, surfactant mixture or a precursor thereof, which corresponds to a preferred embodiment, comprising in particular fatty alcohol polyglycol ethers (fatty alcohol ethoxylates), alkyl phenol polyglycol ethers as well as fatty acid ethoxylates, fatty amine ethoxylates, ethoxylated triglycerides, fatty acids, fatty alcohols, mixed ethers (polyethylene glycol ethers alkylated at both ends), alkyl polyglucosides, sucrose esters, sorbitan esters, fatty acid glucamides (preferably fatty acid N-methylglucamides) and/or amine oxides, in particular alkyl dimethylamine oxides.

Possible ingredients which are melted in a first process step may advantageously also be selected from the group of silicones (silicone oils), paraffins, ester quats, waxes, mono-, di- or triglycerides and/or carbohydrates.

Suitable paraffins may include, for example, octadecane, nonadecane, eicosane, docosane, tricosane, tetracosane, pentacosane, hexacosane, heptacosane, octacosane, nonacosane or triacosane, to name a few examples.

Suitable fatty alcohols may include, for example, 1-tridecanol, 1-tetradecanol, 1-pentadecanol, 1-hexadecanol, 1-heptadecanol, 1-octa-decanol, 9-trans-octadecen-1-ol, 1-nonadecanol, 1-eicosanol, 1-heneicosanol, 1-docosanol, 13-cis-docosen-1-ol, 3-trans-docosen-1-ol to name but a few examples. These also include the so-called wax alcohols, i.e., fatty alcohols with approximately 24-36 carbon atoms, e.g. triacontan-1-ol or melissyl alcohol. This also includes unsaturated fatty alcohols, e.g. elaidyl alcohol, erucyl alcohol or brassidyl alcohol. This also includes Guerbet alcohols, e.g. C₃₂H₆₆O or C₃₆H₇₄O. This also includes alkanediols, e.g. 1,11-undecanediol or 1,12-dodecanediol.

Suitable nonionic surfactants may include, for example, fatty alcohol polyglycol ethers, e.g. C₁₄H₂₉—O—(CH₂CH₂O)₂H, C₁₀H₂₁—O—(CH₂CH₂O)₈H, C₁₂H₂₅—O—(CH₂CH₂O)₆H, C₁₄H₂₉—O—(CH₂CH₂O)₄H, C₁₆H₃₃-Q-(CH₂CH₂O)₁₂H, C₁₈H₃₇—O—(CH₂CH₂O)₄H, to name but a few examples.

Suitable fatty acids may be, for example, capric acid, undecanoic acid, lauric acid, tridecanoic acid, tetradecanoic acid, pentadecanoic acid, palmitic acid, margaric acid, stearic acid, nonadecanoic acid, arachic acid, behenic acid, lignoceric acid, cerotic acid, crotonic acid, erucaic acid, elaeostearic acid or melissic acid, to name a few examples.

The esters of fatty acids, e.g. the methyl or ethyl esters of behenic acid or arachic acid may also be suitable, to name a few examples.

Mono-, di- or triglycerides, e.g. the corresponding glycerides of lauric acid, palmitic acid or capric acid, are also suitable, to name a few examples.

Suitable waxes may include natural waxes, e.g. carnuba wax, candelilla wax, esparto wax, guarum wax, Japan wax, cork wax or montan wax, as well as animal waxes, e.g. beeswax, lanolin, shellac wax or spermaceti; likewise, synthetic waxes, e.g. polyalkylene waxes or polyethylene glycol waxes, as well as chemically modified waxes, e.g. hydrogenated jojoba waxes or montan ester waxes.

If the detergent ingredient to be melted according to the invention, e.g. a surfactant or surfactant mixture, has a melting point in the range of 25-200° C., preferably 30-110° C., advantageously 35-75° C., in particular 40-65° C., this is a preferred embodiment.

According to the invention, at least one solid detergent ingredient and/or liquids are added to the melt before it solidifies.

This liquid may advantageously contain one or more natural or synthetic polymer(s) that is/are preferably water soluble; in particular, such water-soluble polymer(s) may be selected from
i) polyacrylic acid and their salts,
ii) polymethacrylic acid and their salts,
iii) polyvinylpyrrolidone,
iv) vinylpyrrolidone/vinyl ester copolymers,
v) cellulose ethers, starch ethers and guar ethers,
vi) polyvinyl acetates, polyvinyl alcohols and their copolymers,
vii) graft copolymers of polyethylene glycols and vinyl acetate,
viii) alkylacrylamide/acrylic acid copolymers and their salts,
ix) alkylacrylamide/methacrylic acid copolymers and their salts,
x) alkylacrylamide/methyl methacrylic acid copolymers and their salts,
xi) alkylacrylamide/acrylic acid/alkylaminoalkyl (meth)acrylic acid copolymers and their salts,
xii) alkylacrylamide/methacrylic acid/alkylaminoalkyl (meth)acrylic acid copolymers and their salts,
xiii) alkylacrylamide/methyl methacrylic acid/alkylaminoalkyl (meth)acrylic acid copolymers and their salts,
xiv) alkylacrylamide/alkyl methacrylate/alkylaminoalkyl (meth)acrylic acid copolymers and their salts,
xv) copolymers of
xv-i) unsaturated carboxylic acids and their salts,
xv-ii) cationically derivatized unsaturated carboxylic acids and their salts,
xvi) acrylamidoalkyltrialkylammonium chloride/acrylic acid copolymers and their alkali and ammonium salts,
xvii) acrylamidoalkyltrialkylammonium chloride/methacrylic acid copolymers and their alkali and ammonium salts,
xviii) methacroylethylbetaine/methacrylat-copolymere,
xix) vinyl acetate/crotonic acid copolymers,
xx) acrylic acid/ethyl acrylate/N-tert-butylacrylamide terpolymers,
xxi) graft polymers of vinyl esters, esters of acrylic acid or methacrylic acid alone or in combination, copolymerized with crotonic acid, acrylic acid or methacrylic acid with polyalkylene oxides and/or polyalkylene glycols,
xxii) grafted copolymers from copolymerization of
xxii-i) at least one monomer of the nonionic type,
xxii-ii) at least one monomer of the ionic type,
xxiii) by copolymerization of at least one monomer of each of the copolymers obtained from the three following groups:
xxiii-i) esters of unsaturated alcohols and short-chain saturated carboxylic acids and/or esters of short-chain saturated alcohols and unsaturated carboxylic acids,
xxiii-ii) unsaturated carboxylic acids,
xxiii-iii) esters of long-chain carboxylic acids and unsaturated alcohols and/or esters of the carboxylic acids of group d6ii) with saturated or unsaturated, linear or branched C₈₋₁₈ alcohol,
xxiv) biopolymers, in particular xanthan, carageenan, agar, etc.

The liquid may advantageously also contain surfactants, in particular nonionic surfactant(s).

In a preferred embodiment, the liquid includes skin care agents and/or fabric care agents, in particular silicone oil.

Skin care agents may be in particular agents that impart a sensory advantage to the skin, e.g. by supplying lipids and/or moisturizing factors. Skin care agents may be, for example, proteins, amino acids, lecithins, lipoids, phosphatides, plant extracts, vitamins; likewise, fatty alcohols, fatty esters, fatty acid esters, waxes, liquid petrolatum, paraffins may also act as skin care agents. Fabric care agents include, for example, substances for care of fabrics, e.g. cationic surfactants.

These liquids may also be perfume or other oils, for example. However, based on the addition of perfume, it may also be advantageous to apply scent only to the solidified products, e.g. by spraying with perfumes. Other sensitive ingredients, e.g. bleaching agents, enzymes or dyes should only be added subsequently to the process end product, but in principle they may also be incorporated directly by way of the inventive process.

Suitable solid detergent or cleaning agent ingredients which are suitable for incorporation into the melt may be selected from the following, for example:
(a) builder (compounds) such as preferably zeolite (compounds), polycarboxylate (compounds), Na acrylate/maleic acid copolymers, nitrilotriacetic acid, ethylenediaminetetraacetic acid and/or their sodium salts,
(b) carbonates, preferably soda,
(c) bicarbonates, in particular alkali and/or alkaline earth bicarbonates,
(d) sulfates, in particular alkali sulfates and/or alkaline earth sulfates,
(e) builders, e.g. silicates and phosphates, e.g. Na silicate, soda silicates, disilicates, tripolyphosphate, layer silicates,
(f) anionic surfactant compounds (comprising, for example, fatty alcohol sulfates, alkylbenzenesulfonates, alkanesulfonates, alkyl ether sulfates, alkyl sulfates, α-olefin sulfonates and/or ester sulfonates such as in particular methyl ester sulfonate and/or mixtures thereof, soaps),
(g) bleach activators such as in particular N,N,N′,N′-tetraacetylethylene-diamine,
(h) citrates, preferably alkali citrates and/or alkaline earth citrates, in particular Na, K and/or Mg citrates and/or citric acid,
(i) tower powder and/or spray drying products, e.g. containing mixtures of thermally stable ingredients of detergents or cleaning agents,
(j) polymers, e.g. in particular cellulose ether (derivatives) or preferably linear hydrophilic polyethylene terephthalate-polyoxyethylene terephthalate block copolymers (PET-POET polymers),
(k) foam suppressant powders, preferably comprising substances such as natural fats and/or oils, petroleum derivatives and/or silicone oils,
(l) softeners, bentonites, ester quat compounds,
(m) discoloration inhibitors (PVP, etc.).

With regard to the addition of solid detergent or cleaning agent ingredients to the melt, it is preferable for the weight ratio of the starting melt to the added solid detergent or cleaning agent ingredients to be in the range of 1/10 to 10/1, preferably 4/1 to 1/3, in particular 2/1 to 1/2. This corresponds to a preferred embodiment.

According to the invention, it is especially preferable that the solid detergent or cleaning agent ingredients added to the melt have been finely ground in advance, e.g. to particle sizes d₅₀ of <100 μm, preferably to <50 μm, in particular to <25 μm, especially preferably to <10 μm. Fine milling preferably yields particle sizes d₅₀ of <500 μm. Particle sizes d₅₀ of, for example, 1-100 μm, preferably 5-80 μm, in particular 10-50 μm are preferred. These particle sizes d₅₀ are preferably obtained by dry milling methods. Particle sizes d₅₀ in the range of, e.g. 0.05 to 50 μm, preferably 0.1 to 10 μm, in particular 0.5-5 μm are also preferred. These particle sizes d₅₀ are preferably obtained by wet milling methods.

The resulting process products, i.e., the solidified melts and/or melt granules, preferably contain surfactant(s), and anionic, nonionic, cationic and/or amphoteric surfactants may be present. From the standpoint of applications technology in textile detergents, mixtures of anionic and nonionic surfactants are preferred, where the amount of anionic surfactant should be greater than the amount of nonionic surfactants. The total surfactant content of the resulting products is preferably less than 80 wt %, 70 wt %, 60 wt %, 50 wt %, 40 wt %, 30 wt %, 20 wt % or 10 wt %, based on the total agent. The total surfactant content of the resulting products is advantageously at a level greater than 2 wt %, 4 wt %, 6 wt %, 8 wt %, 10 wt %, 12 wt %, 14 wt %, 16 wt % or 18 wt %, based on the total agent.

It is also possible for the total surfactant content to be especially high, for example, >20 wt %, >30 wt % or even >40 wt %. The resulting products may also have, for example, a total surfactant content of >16 wt % up to 60 wt % or, for example, from >4 wt % up to 20 wt % or, for example, from >40 wt % up to 70 wt %.

Within the scope of the present invention, preferred end products of the process (i.e., melt granules and/or the solidified melts) may contain one or more substances from the following group in addition to or independently of the surfactants, namely builders, bleaching agents, bleach activators, enzymes, electrolytes, nonaqueous solvents, pH adjusting agents, scents, perfume vehicles, fluorescent agents, dyes, hydrotopes, foam inhibitors, silicone oils, antiredeposition agents, optical brighteners, graying inhibitors, shrinkage preventing agents, crease preventing agents, dye transfer inhibitors, antimicrobial active ingredients, germicides, fungicides, antioxidants, corrosion inhibitors, antistatics, ironing aids, phobicizing agents and impregnation agents, swelling agents and antislip finishes as well as UV absorbers. These substances may be added to the process product via the melt and/by via addition of solid detergent or cleaning agent ingredients (to the melt).

The builders are especially preferred here. According to a preferred embodiment of the invention, the inventively producible products therefore have a builder content of at least 1 wt %, based on the total inventive product. According to another preferred embodiment of the invention, the builder substance content of the inventive product is 1-99 wt % preferably 1-95 wt % advantageously 5-90 wt %, even more advantageously 10-70 wt %, more preferably 20-60 wt %, based on the total inventive product, in particular 25-50 wt %. According to another preferred embodiment, the lower limit of the builder content may also occur at a value of 2 wt %, 3 wt %, 4 wt %, 6 wt %, 7 wt %, 8 wt %, 9 wt %, 11 wt %, 12 wt %, 13 wt %, 14 wt %, 15 wt %, 16 wt %, 17 wt %, 18 wt %, 19 wt %, 21 wt %, 22 wt %, 23 wt %, 24 wt %, 26 wt %, 27 wt %, 28 wt %, 29 wt % or 30 wt %, each based on the total inventive product. The lower limit may in particular be at even higher values, e.g. at a value of preferably 35 wt %, 40 wt %, 45 wt %, 50 wt %, 55 wt % or 60 wt %, for example, each based on the total inventive product.

According to another preferred embodiment, the upper limit of the builder content may be at a value of, for example, preferably 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt % or 95 wt %, each based on the total inventive product. The upper limit may also occur at lower levels, e.g. at a level of preferably 45 wt %, 40 wt %, 35 wt %, 30 wt % or 25 wt % or even only at a level of 20 wt %, 15 wt % or 10 wt %, each based on the total inventive product. Thus, for example, a builder content of 21 wt % to 68 wt % is possible, to name just one example.

According to a preferred embodiment of the invention, each individual process product that can be produced according to the present invention (e.g. in the form of a pellet, prill, pastille, etc.) contains a complete detergent or cleaning agent recipe, advantageously with the exception of the enzymes, the foam inhibitor granules and the bleaching agents, in particular percarbonate.

According to a preferred embodiment of the invention, the inventively producible process products contain at least 0.5 wt %, based on the total inventive process product, of sodium citrate.

According to another preferred embodiment of the invention, the inventively producible process products have a content of at least 1 wt %, based on the total inventive process product, of polycarboxylates (polymer and/or copolymer).

According to a preferred embodiment of the invention, the inventively producible process products have a perfume content of at least 0.05 wt %, based on the total inventive process product. According to another preferred embodiment of the invention, the perfume content of the inventive process product amounts to 0.1-30 wt %, preferably 1-25 wt %, advantageously 5-22 wt %, in particular 10-20 wt %.

According to a preferred embodiment, enzymes and bleach components are added to the resulting melt granules in the inventive process.

The inventive products may also be partially or entirely coated. In a preferred embodiment, the (optional) coating has colored substances and/or dyes, brighteners and/or pigments advantageously in the nanoscale range or in the micrometer range, preferably white pigments, in particular selected from titanium dioxide pigments such as in particular anatase pigments and/or rutile pigments, zinc sulfide pigments, zinc oxide (zinc white), antimony trioxide (antimony white), basic lead carbonate (lead white) 2PbCO₃Pb(OH)₂, lithopone ZnS+BaSO₄. White auxiliary substances such as preferably calcium carbonate, talc 3MgO.4SiO₂.H₂O and/or barium sulfate may also be present.

In another preferred embodiment, the pigments may be
(a) colored pigments (preferably inorganic colored pigments, in particular iron oxide pigments, chromate pigments, iron blue pigments, chromium oxide pigments, ultramarine pigments, oxidic mixed-phase pigments and/or bismuth vanadate pigments),
(b) black pigments (e.g. aniline black, perylene black, iron oxide pigments, manganese black and/or spinell black),
(c) gloss pigments (preferably lamellar effect pigments, metal effect pigments, e.g. aluminum pigments (silver bronze), copper pigments and copper/zinc pigments (gold bronze) and zinc pigments, pearlized gloss pigments, e.g. magnesium stearate, zinc stearate, lithium stearate or ethylene glycol distearate and/or polyethylene terephthalate, interference pigments, e.g. metal oxide mica pigments) and/or
(d) luminescence pigments, e.g. azomethine fluorescent yellow, silver-doped and/or copper-doped zinc sulfide pigments.

The (optional) coating may be preferably also contain the following substances:
(a) carbonates such as preferably chalk, limestone powder, calcite and/or precipitated calcium carbonate, dolomite and/or barium carbonate,
(b) sulfates such as preferably barite, blanc fixe and/or calcium sulfates,
(c) silicates, preferably talc, pyrophyllite, chlorite, hornblende, mica, kaolin, wollastonite, schist powder, precipitated Ca, Al, Ca/Al, Na/Al silicates, feldspars and/or mullite,
(d) silicas, preferably quartz, fused quartz, cristobalite, kieselgur, Neuburger diatomaceous earth, precipitated silica, pyrogenic silica, glass powder, powdered pumice, perlite, Ca metasilicates and/or fibers of melts of glass, basalts, slags,
(e) oxides such as aluminum oxide and/or magnesium hydroxide in particular,
(f) organic fibers such as textile fibers, cellulose fibers, polyethylene fibers, polypropylene fibers, polyamide fibers, polyacrylonitrile fibers and/or polyester fibers in particular, preferably with lengths in the nanometer and/or micrometer range and/or
(g) meals such as starch powder.

Inventive products that are coated with a thermoplastic such as preferably PEG, PVA, polyacrylates, PVP, carbohydrates, polyesters such as preferably PET are a preferred embodiment of the invention.

The optional coating according to the invention may also include all other coating agents not mentioned here. Coating agents include, for example, substances that impart a glossy appearance to the outside surface of the object (to be coated) and/or form a coating (a sheathing) on the outside surface. Solid and/or liquid substances may be used as the coating agent, preferably those which suppress or delay the penetration of moisture or can prevent or delay the loss of aroma.

Suitable coating agents may contain, for example, water-soluble, water-dispersible and/or water-insoluble (co)polymers. The optional coating layer as such may be water soluble or water insoluble, for example.

Water-soluble polymers contain a sufficient number of hydrophilic groups for the water solubility and are advantageously not crosslinked. The hydrophilic groups may be nonionic, anionic, cationic or zwitterionic, e.g. —NH₂, —OH, —SH, —O—, —COOH, —COO-M⁺, —SO₃⁻M⁺, —PO₃²⁻M²⁺, —NH₃⁺,

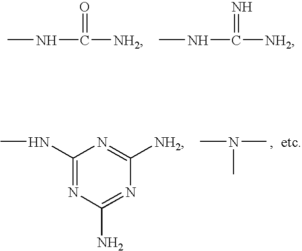

The individual polymers may contain different hydrophilic groups at the same time, e.g. ionic and nonionic and/or anionic groups in addition to cationic groups. Preferred water-soluble polymers may be, for example, natural polysaccharides and/or polypeptides, e.g. starch, alginates, pectins, vegetable gums, caseins, gelatins, etc. Preferred water-soluble polymer may be, for example, semisynthetic polymers, e.g. cellulose ethers or starch ethers. Preferred water-soluble polymers may be, for example, bioengineered products, e.g. pullulan, curdlan or xanthan. Preferred water-soluble polymers may be, for example, synthetic polymers, e.g. homopolymers and copolymers of (meth)acrylic acid and their derivatives, maleic acid, vinylsulfonic acid, vinylphosphonic acid, polyvinyl alcohol, polyethyleneimine, polyvinylpyrrolidone, etc. Preferred coating agents contain water-soluble (co)polymer, in particular with a melting point or softening point in the range of 48° C. to 300° C., preferably in the range of 48° C. to 200° C. Suitable water-soluble (co)polymer with a corresponding melting point or softening point may be selected from the group consisting of polyalkylene glycols, polyethylene terephthalates, polyvinyl alcohols and mixtures thereof.

The optional coating may comprise, in addition to the actual coating agent or independently thereof, other ingredients, e.g. advantageously fabric softening compounds and/or perfume.

It is also possible to coat the particles several times, for example, by surrounding the particles first with a first coating, e.g. containing a fabric softening compound, and then to provide the resulting object with another sheathing, e.g. containing a water-soluble polymer and perfume.

According to a preferred embodiment, the optional coating contains lipids and/or silicone oils. Preferred lipids include
(a) lipophilic hydrocarbons (e.g. also triacontane, squalene or carotinoids, etc.),
(b) lipophilic alcohols (e.g. wax alcohols, retinol or cholesterol, etc.),
(c) ether lipids,
(d) lipophilic carboxylic acids (fatty acids),
(e) lipophilic esters (such as neutral fats, i.e., mono-, di- and triacylglycerols (triglycerides), sterol esters, etc.),
(f) lipophilic amides (such as ceramides, etc.),
(g) waxes,
(h) lipids with more than two hydrolysis products, e.g. glycolipids, phospholipids, sphingolipids and/or glycerol lipids, etc.,
(i) lipids in the form of higher molecular conjugates with more than two hydrolysis products, e.g. lipoproteins and/or liposaccharides, etc.,
(j) phosphorus-free glycolipids, e.g. glycosphingolipids (such as preferably cerebrosides, gangliosides, sulfatides) or e.g. glycoglycerolipids (such as preferably glycosyl diglycerides and monoglycerides), etc.,
(k) carbohydrate-free phospholipids, e.g. sphingophospholipids (such as preferably sphingomyelins) or, e.g. glycerophospholipids (such as preferably lecithins, kephalins, cardiolipins, phosphatidylinositol and inositol phosphates, etc.),
(l) mixtures of the aforementioned.

The bulk density of the inventive end products of the process is adjustable variably via the inventive process. At a bulk density of the product producible according to the invention in the range of 200-1500 g/L, this is also a preferred embodiment of the invention. The lower limit for the bulk density may be at a value of preferably 250, 300, 350, 400, 450, 500, 550, 600, 650, 700 or even 750 g/L. It is also possible for the lower limit to be even higher, e.g. 800 g/L. With this process, it is also possible with no problem to adjust the bulk densities in the range of 520 to 620 g/L.

The upper limit for the bulk density may lie at a value of preferably 1450, 1400, 1350, 1300, 1250, 1200, 1150, 1100, 1050, 1000, 950, 900, 850, 800 or 750 g/L. It is also possible for the upper limit to be even lower, e.g. at a value of preferably 700, 650, 600, 550 or 500 g/L.

The products of the process according to the invention may advantageously have particle sizes d₅₀ of 0.2-10 mm, preferably 0.6 to 7.5 mm and in particular from 0.8 to 2 mm.

Another subject of the present invention is a detergent or cleaning agent containing products producible according to the invention in particular a detergent containing care components. All fabric pretreatment agents, fabric after-treatment agents, fabric treatment agents, conditioners, finishing agents and laundry softening agents also fall under the term of detergents or cleaning agents.

It is therefore advantageous in particular if the resulting product contains swellable layer silicates, e.g. in amounts of 0.1-50 wt %, preferably 1-40 wt %, advantageously 2-30 wt % in particular 4.20 wt %, preferably montmorillonites, in particular bentonite, whereby advantageously in addition 0.005 wt % to 20 wt %, based on the weight of the layer silicate, of a polymeric clay flocculant is also contained therein (preferably polymers with a weight-average molecular weight of 150,000 to 5,000,000, whereby the polymer is derived from monomers selected from ethylene oxide, acrylamide and acrylic acid, in particular high-molecular polyethylene oxide).

Another subject of the invention is a cleaning agent containing products producible according to the invention, preferably dishwashing agents containing
(a) cleaning components containing, for example, surfactants such as preferably alkanesulfonates, alkyl ether sulfates, alkyl polyglucosides and/or cocoamidopropyl betaine,
(b) clear rinse components containing for example nonionic surfactants, preferably based on fatty alcohol, in particular with additives of low alcohols as solubilizers and advantageously of citric acid,
(c) softening components containing, for example, phosphonate, polycarboxylate, sodium gluconate, ethylenediaminetetraacetic acid (EDTA), nitrilotriacetic acid (NTA) and/or aluminum silicates (zeolites),
(d) optionally: additional ingredients such as preferably silver/glass protective components.

According to a preferred embodiment, the inventive product contains ingredients for cleaning, care, conditioning and/or after-treating textiles, According to a preferred embodiment, the inventive product contains ingredients for cleaning and/or care of dishes, glasses, utensils and the like.

In another preferred embodiment, the inventive product contains one or more skin-care active ingredients.

It may be preferable for the detergent or cleaning agent ingredient that is to be melted to contain at least one skin-care active ingredient and/or at least one skin-care active ingredient mixed with the melt.

In a preferred embodiment, the inventive method is characterized in that fabric softening ingredients, preferably comprising polysiloxanes, fabric softening clays, preferably bentonite and/or cationic polymers are mixed with the melt.

In a preferred embodiment, the inventive agents are characterized in that the skin-care active ingredients which they contain and which are released in the course of the washing process, preferably in the rinse cycle, are transferred at least partially to the fibers of the textile laundry goods and remain at least partially on the latter even after the end of the washing process, whereby these skin-care active ingredients are released to the skin at least partially from the fabric washed with them when skin comes in contact with a fabric washed accordingly and thereby can reach the skin advantageously.

Skin-care active ingredients include all those active ingredients that impart a sensory and/or cosmetic advantage to the skin. Skin-care active ingredients are preferably selected from the following substances:
a) waxes such as carnuba, spermaceti, beeswax, lanolin and/or derivatives thereof and others,
b) hydrophobic plant extracts,
c) hydrocarbons, e.g. squalenes and/or squalanes,
d) higher fatty acids, preferably those with at least 12 carbon atoms, e.g. lauric acid, stearic acid, behenic acid, myristic acid, palmitic acid, oleic acid, linoleic acid, linolenic acid, isostearic acid and/or polyunsaturated fatty acids and others,
e) higher fatty alcohols, preferably those with at least 12 carbon atoms, e.g. lauryl alcohol, cetyl alcohol, stearyl alcohol, oleyl alcohol, behenyl alcohol, cholesterol and/or 2-hexadecanol and others,
f) esters, preferably those such as cetyl octanoate, lauryl lactates, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate and/or alkyl tartrate and others,
g) lipids such as cholesterol, ceramide and/or sucrose esters and others,
h) vitamins such as vitamins A and E, vitamin alkyl esters, including vitamin C alkyl esters and others,
i) sunscreen agents,
j) phospholipids,
k) derivatives of α-hydroxy acids,
l) perfumes,
m) germicides for cosmetic use, both synthetic germicides, e.g. salicylic acid and/or others, as well as natural germicides, e.g. neem oil and/or others,
n) silicones,
   as well as mixtures of any of the aforementioned components.

The invention also relates to the use of an inventive detergent which has inventive process products, optionally coated, in a laundry washing process and/or a machine washing process.

Neither the inventive process nor the inventive agent is fundamentally limited to the field of detergents and cleaning agents, but such agents and/or methods constitute especially preferred embodiments of the invention.

The ingredients contained in the process products (melt granules) to be produced according to this invention are preferably selected from the group comprising surfactants, scents, dyes, builders, substances to adjust the pH, bleaching agents, bleach activators, enzymes, electrolytes, nonaqueous solvents, dirt repellant substances, optical brighteners, graying inhibitors, disintegrating aids, scents, perfume vehicles, fluorescent agents, dyes, hydrotopes, foam inhibitors, silicone oils, antiredeposition agents, optical brighteners, graying inhibitors, shrinkage preventing agents, crease-preventing agents, dye transfer inhibitors, antimicrobial active ingredients, germicides, fungicides, antioxidants, corrosion inhibitors, antistatics, ironing aids, phobicizing agents and impregnation agents, swelling agents and antislip agents, UV absorbers, conventional additives and/or mixtures thereof.

In addition, all other detergent and/or cleaning agent ingredients with which those skilled in the art are familiar from the state of the art, although not mentioned explicitly here, may in the usual amounts be components of the products of the process to be produced according to this invention.

In this context, melt granules for detergents or cleaning agents obtainable by the inventive method and obtainable in the form of wafers or rods with a geometric length:width:thickness ratio in the range of 1:0.1-1:<0.1-0.005 are another subject of the invention.

Another subject of the invention in this context are melt granules for detergents or cleaning agents obtainable by a method according to the invention in the form of cubes, cuboids, trapezoid, rings, tubes, cones, cylinders or stars, preferably with a hole.

Another subject of the present invention in this context is melt granules for detergents or cleaning agents obtainable by an inventive method in the form of beads with an average shape factor of >0.84, in particular >0.86 preferably >0.88.

The shape factor in the sense of the present invention can be determined accurately by modern particle measurement techniques using digital image processing. In a typical particle shape analysis, such as that which can be performed with the Camsizer® system from Retsch Technology or with the KeSizer® from the Kemira Co., is based on irradiating the particles and/or the bulk material with a light source and detecting the particles as projected areas, then digitizing and processing the results by computer technology. The determination of the surface curvature is performed by an optical measurement method, in which the “shadow cast” of the parts to be analyzed is determined and converted to a corresponding shape factor. The underlying principle for determination of the shape factor has been described for example by Gordon Rittenhouse in “A Visual Method of Estimating Two-Dimensional Sphericity” in the Journal of Sedimentary Petrology, vol. 13, no. 2, pages 79-81. The measurement limits of this optical analysis method are 15 μm and/or 90 mm. The numerical values for d₅₀ and d₉₀ are also obtainable by the aforementioned measurement method.

Another subject of the invention in this context is melt granules for detergents or cleaning agents, obtainable by the inventive method, having characters, letters or symbols as an elevation or recess.

The melt granules may be provided with long-lasting scents, naturally colored in any colors and designed to be glossy at the surface.

When speaking of inventive detergents or cleaning agents or inventive agents below, this refers to the inventive process end products (melt granules).

A few especially suitable detergents and/or cleaning agent ingredients according to the invention are explained in greater detail below. These ingredients may be contained in the inventive process products themselves and/or in corresponding additives, which may optionally be added to the inventive process products, if this is required or desired, e.g. to obtain a more valuable detergent and/or cleaning agent. All the ingredients listed below are purely optional but they may also preferably be present. However, nonionic surfactant is present according to the invention.

Anionic surfactants may be preferably be contained in the inventive detergents or cleaning agents. Anionic surfactants that are used include, for example, those of the sulfonate and sulfate type. Surfactants of the sulfate type preferably include C₉₋₁₃ alkylbenzenesulfonates, olefin sulfonates, i.e., mixtures of alkenesulfonates and hydroxyalkanesulfonates as well as disulfonates, such as those obtained from, for example, C₁₂₋₁₈ monoolefins with terminal or internal double bonds by sulfonation with gaseous sulfur trioxide and then alkaline or acidic hydrolysis of the sulfonation products. Also suitable are alkanesulfonates obtained from C₁₂₋₁₈ alkanes, e.g. by sulfochlorination or sulfoxidation with subsequent hydrolysis and/or neutralization. Likewise, the esters of α-sulfofatty acids (ester sulfonates), e.g. the α-sulfonated methyl esters of hydrogenated coco fatty acids, palm kernel fatty acids or tallow fatty acids are also suitable.

The anionic surfactant content of the inventive detergents or cleaning agents may vary in wide ranges, depending on the purpose of the respective agent. For example, an inventive agent may contain very large amounts of anionic surfactant, preferably up to the order of 40 wt %, 50 wt % or 60 wt % or more. Likewise, an inventive agent may contain only very small amounts of anionic surfactant, e.g. less than 15 wt % or 10 wt % or less than 5 wt % or even less than that. Advantageously, however, the inventive agents contain anionic surfactants in amounts of 1 wt % to 40 wt % and in particular 5 wt % to 30 wt %, but concentrations above 10 wt % or even above 15 wt % are especially preferred. According to a preferred embodiment, the inventive detergent or cleaning agent contains anionic surfactants, preferably in amounts of at least 0.1 wt %, based on the total detergent or cleaning agent. According to another preferred embodiment, the inventive agent is largely free of anionic surfactant, so it advantageously contains <5 wt % anionic surfactant, preferably <1 wt % or in particular no anionic surfactant.

In addition to the aforementioned anionic surfactants, but also independently thereof, soaps may also be contained in the inventive detergents or cleaning agents. Suitable soaps include in particular saturated fatty acid soaps such as the salts of lauric acid, myristic acid, palmitic acid, stearic acid, hydrogenated erucaic acid and behenic acid as well as in particular natural fatty acids, e.g. coco, palm kernel or tallow fatty acids. The soap content in the agent preferably amounts to no more than 3 wt % and in particular 0.5 wt % to 2.5 wt %, based on the total agent, independently of other anionic surfactants. According to a preferred embodiment, the inventive agent is free of soap.

The anionic surfactants and soaps may be present in the form of their sodium, potassium or ammonium salts as well as in the form of soluble salts of organic bases such as mono-, di- or triethanolamine. They are preferably present in the form of their sodium or potassium salts, in particular in the form of the sodium salts. Anionic surfactants and soaps may also be synthesized in situ by introducing the anionic surfactant acids and optionally fatty acids, which are then neutralized by the alkali carriers in the composition that is to be spray dried, into the composition to be spray dried.

According to the invention, nonionic surfactants are present in the inventive detergents or cleaning agents. For example, their content may be up to 2 wt % or 3 wt % or 5 wt %. Larger amounts of nonionic surfactant may also be present, e.g. up to 5 wt % or 10 wt % or 15 wt % or 20 wt %, 30 wt %, 40 wt % or up to 50 wt % or even more if it is expedient, e.g. up to 60 wt %. Reasonable lower limits may lie at values of 0.01 wt %, 0.1 wt %, 1 wt %, 2 wt %, 3 wt % or 4 wt %. Higher lower limits are also possible, e.g. 5 wt %, 6 wt %, 7 wt %, 8 wt %, 9 wt %, 10 wt %, 12 wt %, 14 wt %, 16 wt %, 18 wt %, 20 wt %, 25 wt %, 30 wt %, 35 wt % or even 40 wt %, each based on the total agent (melt granules).

However, the nonionic surfactants are preferably present in larger amounts, e.g. up to 50 wt %, advantageously from 0.1 to 40 wt %, especially preferably from 0.5 to 30 wt % and in particular from 2 to 25 wt %, each based on the total agent.

According to a preferred embodiment, the inventive detergent or cleaning agent contains nonionic surfactants, preferably in amounts of at least 0.1 wt %, based on the total detergent or cleaning agent. According to another preferred embodiment, the inventive agent is largely free of nonionic surfactants, so it advantageously contains <5 wt %, preferably <1 wt % nonionic surfactant.

At any rate, the present invention makes it possible to provide solid detergents or cleaning agents, which may have high nonionic surfactant contents but nevertheless do not have any problems with tackiness. Advantageously all the nonionic surfactants known from the state of the art may be contained in the inventive agents.

Preferably alkoxylated, advantageously ethoxylated, in particular primary alcohols with preferably 8 to 18 carbon atoms and an average of 1 to 12 mol ethylene oxide (EO) per mol alcohol are used as the nonionic surfactants, in which the alcohol radical may be linear or preferably with methyl branching in position 2 and/or may contain linear and/or methyl-branched radicals in mixture such as those usually found in oxoalcohol radicals. In particular, however, alcoholic oxalates with linear radicals from alcohols of native origin with 12 to 18 carbon atoms, e.g. from coco, palm, palm kernel, tallow fat or oleyl alcohol and an average of 2 to 8 EO per mol alcohol are preferred. The preferred ethoxylated alcohols include, for example, C₁₂-C₁₄ alcohols with 3 EO to 6 EO, C₉-C₁₁ alcohols with 7 EO, C₁₃-C₁₅ alcohols with 3 EO, 5 EO, 7 EO or 8 EO, C₁₄-C₁₅ alcohols with 4 EO, 5 EO, 7 EO or 9 EO, C₁₂-C₁₈ alcohols with 3 EO, 5 EO or 7 EO and mixtures of these such as mixtures of C₁₂-C₁₄ alcohol with 3 EO and C₁₂-C₁₈ alcohol with 7 EO. The stated degrees of ethoxylation are statistical averages, which may be an integer or a fraction for a specific product.

Preferred alcohol ethoxylates have a narrow range homolog distribution (narrow range ethoxylates, NRE). In addition to these nonionic surfactants, fatty alcohols with more than 12 EO may also be used. Examples of these include (tallow) fatty alcohols with 14 EO, 16 EO, 20 EO, 25 EO, 30 EO or 40 EO.

Preferred nonionic surfactants include one or more branched or unbranched, saturated or unsaturated C₁₀-C₂₂ alcohols alkoxylated with ethylene oxide (EO) and/or propylene oxide (PO) with a degree of ethoxylation of up to 30, preferably ethoxylated C₁₀₋₁₈ fatty alcohols with a degree of ethoxylation of less than 30, preferably 1 to 20, in particular 1 to 12, especially preferably 1 to 8, extremely preferably 2 to 5, e.g. C₁₂₋₁₄ fatty alcohol ethoxylates with 2, 3 or 4 EO or a mixture of C₁₂₋₁₄ fatty alcohol ethoxylates with 3 and 4 EO in a weight ratio of 1 to 1 or isotridecyl alcohol ethoxylate with 5, 8 or 12 EO.

Furthermore, additional nonionic surfactants may include alkyl glycosides of the general formula RO(G)ₓ, where R denotes a primary, linear or methyl-branched aliphatic radical, in particular with the methyl branching in position 2, with 8 to 22 carbon atoms, preferably 12 to 18 carbon atoms, and G is the symbol standing for a glycose unit with 5 or 6 carbon atoms, preferably glucose. The degree of oligomerization x, which indicates the distribution of monoglycosides and oligoglycosides, is any number from 1 to 10; x is preferably 1.1 to 1.4.

Another class of nonionic surfactants that may preferably be used, either as an exclusive nonionic surfactant or in combination with other nonionic surfactants, in particular together with alkoxylated fatty alcohols and/or alkyl glycosides, comprises alkoxylated, preferably ethoxylated or ethoxylated and propoxylated fatty acid alkyl esters, preferably with 1 to 4 carbon atoms in the alkyl chain, in particular fatty acid methyl esters, especially preferably C₁₂-C₁₈ fatty acid methyl esters with an average of 3 to 15 EO, in particular with an average of 5 to 12 EO.

Nonionic surfactants of the amine oxide type, e.g. N-cocoalkyl-N,N-dimethylamine oxide and N-tallow alkyl-N,N-dihydroxyethylamine oxide and of the fatty acid alkanolamide type may also be suitable. The amount of these nonionic surfactants is preferably no more than that of the ethoxylated fatty alcohols, in particular no more than half thereof.

Also suitable are alkoxylated amines, advantageously ethoxylated and/or propoxylated amines, in particular primary and secondary amines, preferably with 1 to 18 carbon atoms per alkyl chain and an average of 1 to 12 mol ethylene oxide (EO) and/or 1 to 10 mol propylene oxide (PO) per mol amine.

The inventive detergents or cleaning agents may preferably also contain cationic surfactants. Suitable cationic surfactants include, for example, surface-active quaternary compounds, in particular with an ammonium, sulfonium, phosphonium, iodonium or arsonium group. By using quaternary surface active compounds with an antimicrobial effect, the agent may be designed to have an antimicrobial effect and/or its antimicrobial effect, which is optionally already present due to other ingredients, may be improved.

The inventive detergents or cleaning agents may contain one or more cationic surfactants, advantageously in amounts, based on the total composition, of 0 to 30 wt %, more advantageously greater than 0 to 20 wt %, preferably 0.01 to 10 wt %, in particular 0.1 to 5 wt %. Suitable minimum values may also be 0.5, 1, 2 or 3 wt %. According to a preferred embodiment, the inventive detergent or cleaning agent contains cationic surfactants, preferably in amounts of at least 0.1 wt %, based on the total detergent or cleaning agent. According to another preferred embodiment, the inventive agent is largely free of cationic surfactant, so it advantageously contains <5 wt %, preferably <1 wt % cationic surfactant, in particular no cationic surfactant.

Other ingredients of the inventive process products may be organic and inorganic builder substances. The inorganic builder substances include water-insoluble or non-water-soluble ingredients such as aluminosilicates and in particular zeolites.

In a preferred embodiment of the invention, carbonates and silicates in particular are used as inorganic builder substances.

Especially preferred in organic water-soluble builders are alkali metal carbonates and alkali metal bicarbonates, but sodium and potassium carbonate and in particular sodium carbonate are among the preferred embodiments. The alkali metal carbonate content in zeolite-free agents in particular may vary in a very broad range and preferably amounts to 1 to 50 wt %, advantageously 5 to 40 wt %, in particular 8 to 30 wt %, whereby the alkali metal carbonate content is usually higher than the (X-ray)-amorphous silicate content. According to another preferred embodiment, the inventive detergent or cleaning agent is free of alkali metal carbonates.

The organic builder substance content of the detergents or cleaning agents may vary in a broad range. Contents of 2 to 20 wt % are preferred, and contents of max. 10 wt % being especially preferred. According to another preferred embodiment, the inventive detergent or cleaning agent is free of organic builder substances.

It should be pointed out here that unless otherwise indicated, amounts given in wt % refer to the total detergent or cleaning agent, i.e., the end product of the inventive process.

The inventive detergent or cleaning agents may contain components from the classes of graying inhibitors (dirt carriers), neutral salts and/or fabric softening aids (e.g. cationic surfactants), which is preferred.

In addition, the inventive agents may be conditions and may contain components accordingly. The term “conditioning” is preferably understood in the sense of this invention to refer to the finishing treatment of textiles, cloth and fabrics. Positive properties are imparted to the textiles by the conditioning, e.g. an improved soft feel, an increased gloss and color brilliance, an improved scent impression, reduced felting, ease of ironing due to a reduction in the sliding properties, a reduction in wrinkling and static charge as well as dye transfer inhibition in dyed textiles.

To improve the soft feel and finishing properties, the inventive agents may contain fabric softener components. Examples of such compounds include quaternary ammonium compounds, cationic polymers and emulsifiers such as those used in hair care agents and also in agents for fabric finishing. These softening compounds, which are also described in greater detail below, may be used in all the inventive agents, but in particular in the conditioning agents and/or in agents with the desired fabric softening effect.

Especially preferred are the alkylated quaternary ammonium compounds, of which at least one alkyl chain is interrupted by an ester group and/or an amido group, in particular N-methyl-N-(2-hydroxyethyl)-N,N-(ditallow acyloxyethyl)ammonium methosulfate.

Especially polyoxyalkylene glycerol alkanoates, polybutylenes, long-chain fatty acids, ethoxylated fatty acid ethanolamides, alkyl polyglycosides, in particular sorbitan monoesters, diesters and triesters and fatty acid esters of polycarboxylic acids may be considered as the nonionic softeners.

Fabric softeners, e.g. bentonite, may be contained in an inventive agent, e.g. preferably a conditioning agent, in amounts of 0.1 to 80 wt %, usually 0.1 to 70 wt %, preferably 0.2 to 60 wt % and in particular 0.5 to 40 wt %, each based on the total agent.

In a preferred embodiment, the inventive detergent or cleaning agent such as a conditioning agent in particular, may optionally contain one or more chelating agents.

Complexing agents (INCl chelating agents), also known as sequestrants, are ingredients capable of complexing metal ions and inactivating them, e.g. to prevent their negative effects on the stability or appearance of the agents, e.g. turbidity. First, it is important to chelate the calcium and magnesium ions of water hardness which are incompatible with many ingredients. Chelation of the ions of heavy metals such as iron or copper delays the oxidative decomposition of the finished agents.

The inventive detergents or cleaning agents such as conditioning agents in particular advantageously contain chelating agents in an amount of usually 0 to 20 wt %, preferably 0.1 to 15 wt %, in particular 0.5 to 10 wt %, especially preferably 1 to 8 wt %, extremely preferably 1.5 to 6 wt %, based on the total agent.

In another embodiment, the inventive detergent or cleaning agent such as conditioning agents in particular, optionally contains one or more enzymes. According to another preferred embodiment, the inventive product is free of enzymes, however.

The enzymes used may in particular be those from the classes of hydrolases such as proteases, esterases, lipases and/or lipolytic enzymes, amylases, cellulases and/or other glycosyl hydrolases and mixtures of said enzymes. All these hydrolases contribute toward removing spots such as spots containing protein, fat or starch and graying in the laundry. Cellulases and other glycosyl hydrolases may also contribute toward maintaining color and toward increasing the softness of the textile due to the removal of pilling and microfibrils. For bleaching and for inhibiting dye transfer, oxyreductases may also be used.

It should also be pointed out that all the ingredients mentioned here in conjunction with the inventive detergents or cleaning agents, i.e., the inventive process products may also be contained in other solid additives which may if desired be added subsequently to the inventive process products to obtain further improved detergents or cleaning agents.

Another subject of the invention is thus a detergent or cleaning agent containing inventive process products as well as particulate additives (e.g. in the form of granules, etc.) comprising ingredients selected from the group of surfactants, builders, bleaching agents, bleach activators, enzymes, electrolytes, nonaqueous solvents, pH adjusting agents, scents, perfume carriers, fluorescent agents, dyes, hydrotopes, foam inhibitors, silicone oils, antiredeposition agents, optical brighteners, graying inhibitors, shrinkage preventing agents, crease-preventing agents, dye transfer inhibitors, antimicrobial active ingredients, germicides, fungicides, antioxidants, corrosion inhibitors, antistatics, ironing aids, phobicizing agents and impregnating agents, swelling and antislip agents as well as UV absorbers. Such a detergent or cleaning agent may contain, for example, 1-95 wt %, 2-90 wt %, 3-80 wt %, 4-70 wt %, 5-60 wt %, 10-50 wt %, 15-40 wt % or 20-30 wt % of the inventive process products and the remaining (to 100 wt %) particulate additives.

An inventive solid process product may preferably contain, for example, components selected from the following, e.g.:

anionic surfactants, e.g. alkylbenzenesulfonate, alkyl sulfate in amounts of advantageously 5-30 wt %, preferably 8-15 wt %, in particular 15-20 wt %,

nonionic surfactants, e.g. fatty alcohol polyglycol ethers, alkyl polyglucoside, fatty acid glucamide, advantageous in amounts of 0.1-20 wt %, preferably 2-15 wt %, in particular 6-11 wt %,

builders, e.g. zeolite, polycarboxylate, sodium citrate, e.g. in amounts of 5-60 wt %, preferably in amounts of 10-15 wt %, in particular 15-40 wt %,

alkalies, e.g. sodium carbonate, advantageously in amounts of 1-30 wt %, preferably 2-25 wt %, in particular 5-20 wt %,

bleaching agents, e.g. sodium perborate, sodium percarbonate, advantageously in amounts of 0-25 wt %, preferably 10-20 wt %,

corrosion inhibitors, e.g. sodium silicate, advantageously in amounts of 1-6 wt %, preferably 2-5 wt %, in particular 3-4 wt %,

stabilizers, e.g. phosphonates, advantageously in amounts of 0-1 wt %,

foam inhibitors, e.g. soap, silicone oils, paraffins, advantageously in amounts of 0.1-4 wt %, preferably 0.2-2 wt %, in particular 1-3 wt %,

enzymes, e.g. proteases, amylases, cellulases, lipases, advantageously in amounts of 0-2 wt % preferably 0.1-1 wt %, in particular 0.3-0.8 wt %,

graying inhibitors, e.g. carboxymethyl cellulose, advantageously in amounts of 0-1 wt %,

discoloration inhibitors, e.g. polyvinylpyrrolidone derivatives, advantageously in amounts of 0-2 wt %,

adjusting agents, e.g. sodium sulfate, advantageously in amounts of 0-20 wt %,

optical brighteners, e.g. stilbene derivative, biphenyl derivative, advantageously in amounts of 0.1-0.3 wt %, in particular 0.1-0.4 wt %,

scents,

water,

soap,

bleach activators,

cellulose derivatives,

dirt repellants.

An inventive detergent of cleaning agent containing an inventive process product and additional solid additives may preferably contain components, for example, which are selected from the following, among others:

anionic surfactants, e.g. alkylbenzenesulfonate, alkyl sulfate in amounts of advantageously 5-30 wt %, preferably 8-15 wt %, in particular 15-20 wt %,

nonionic surfactants, e.g. fatty alcohol polyglycol ethers, alkyl polyglucoside, fatty acid glucamide, advantageous in amounts of 0.1-20 wt %, preferably 2-15 wt %, in particular 6-11 wt %,

builders, e.g. zeolite, polycarboxylate, sodium citrate, e.g. in amounts of 5-60 wt %, preferably in amounts of 10-15 wt %, in particular 15-40 wt %,

alkalies, e.g. sodium carbonate, advantageously in amounts of 1-30 wt %, preferably 2-25 wt %, in particular 5-20 wt %,

bleaching agents, e.g. sodium perborate, sodium percarbonate, advantageously in amounts of 0-25 wt %, preferably 10-20 wt %,

corrosion inhibitors, e.g. sodium silicate, advantageously in amounts of 1-6 wt %, preferably 2-5 wt %, in particular 3-4 wt %,

stabilizers, e.g. phosphonates, advantageously in amounts of 0-1 wt %,

foam inhibitors, e.g. soap, silicone oils, paraffins, advantageously in amounts of 0.1-4 wt %, preferably 0.2-2 wt %, in particular 1-3 wt %,

enzymes, e.g. proteases, amylases, cellulases, lipases, advantageously in amounts of 0-2 wt % preferably 0.1-1 wt %, in particular 0.3-0.8 wt %,

graying inhibitors, e.g. carboxymethyl cellulose, advantageously in amounts of 0-1 wt %,

discoloration inhibitors, e.g. polyvinylpyrrolidone derivatives, advantageously in amounts of 0-2 wt %,

adjusting agents, e.g. sodium sulfate, advantageously in amounts of 0-20 wt %,

optical brighteners, e.g. stilbene derivative, biphenyl derivative, advantageously in amounts of 0.1-0.3 wt %, in particular 0.1-0.4 wt %,

scents,

water,

soap,

bleach activators,

cellulose derivatives,

dirt repellants,

whereby these components may be contained in the additives and/or in the inventive process product.

The inventive detergents or cleaning agents may preferably also be perfumed with perfume oil (fragrances, scents).

Another subject of the invention is the use of the inventive process products in mixture with enzymes and bleaching agents for washing laundry.

Another subject of the invention is the use of the inventive process products for scenting rooms, vehicles or cabinets, in particular in the form of scent bags.

Another subject of the invention is the use of the inventive process products for scenting objects, preferably detergents, washing machines and cleaning machines, dry laundry and packages.

Another subject of the invention is the use of the inventive process products for scenting textiles during the washing or drying process, preferably by machine.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

It is understood that the embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

What is claimed:

1. A process for producing solid water-free nonionic detergents or cleaning agents or components in the form of melt granules, comprising the steps of:
a) melting at least one detergent or cleaning agent ingredient that is solid at room temperature to form a melt;
b) mixing the melt with at least one other solid detergent or cleaning agent ingredient or at least one liquid to form a mixture,
c) solidifying the mixture by cooling to form the melt granules.

2. The process of claim 1, wherein the at least one detergent or cleaning agent ingredient that is solid at room temperature comprises a surfactant or surfactant-containing preproduct.

3. The method of claim 1, wherein the mixture is cast in a shape before solidifying.

4. The method of claim 1, wherein in step (c) the mixture is dripped into a cooling stream to form beads sprayed to form a powder.

5. The method of claim 1, wherein in step (c) the mixture is pastilled, flaked, or converted to strips by cooling on a steel roller or a steel belt.

6. The method of claim 2, wherein the detergent or cleaning agent ingredient that is solid at room temperature comprises one or more fatty alcohol polyglycol ethers, fatty alcohol ethoxylates, alkyl phenol polyglycol ethers, fatty acid ethoxylates, fatty amine ethoxylates, ethoxylated triglycerides, fatty acids, fatty alcohols, mixed ethers, alkyl polyglucosides, sucrose esters, sorbitan esters, fatty acid glucamides, fatty acid amine oxides, or alkyl dimethylamine oxides.

7. The method of claim 1, wherein the at least one the detergent or cleaning agent ingredient to be melted has a melting point of 25° C. to 200° C.

8. The method of claim 7, wherein the at least one the detergent or cleaning agent ingredient to be melted has a melting point of 30° C. to 110° C.

9. The method of claim 1, wherein the solid detergent or cleaning agent ingredient or ingredients that are incorporated into the melt comprise one or more:
(a) builder compounds;
(b) carbonates;
(c) bicarbonates;
(d) sulfates;
(e) silicates or phosphates;
(f) anionic surfactant compounds;
(g) bleach activators;
(h) citrates;
(i) tower powders or spray-drying products;
(j) polymers;
(k) foam suppressant powders;
(l) water softeners, bentonites, or esterquat compounds; or
(m) discoloration inhibitors.

10. The method of claim 1, wherein the melt and the solid detergent or cleaning agent ingredient or ingredients mixed with the melt in (b) have a weight ratio of 1/10 to 10/1.

11. The method of claim 10, wherein the melt and the solid detergent or cleaning agent ingredient or ingredients mixed with the melt in (b) have a weight ratio of 4/1 to 1/3.

12. The method of claim 1, wherein the solid detergent or cleaning agent ingredient or ingredients mixed with the melt in (b) have a particle size d₅₀ of <100 μm.

13. The method of claim 12, wherein the solid detergent or cleaning agent ingredient or ingredients mixed with the melt in (b) have a particle size d₅₀ of <50 μm.

14. The method of claim 1, wherein the at least one detergent or cleaning agent ingredient to be melted contains at least one skin-care active ingredient or at least one skin-care active ingredient is mixed with the melt.

15. The method of claim 1, wherein a fabric softening ingredient is mixed with the melt.

16. The method of claim 1, wherein enzymes and bleach components are added to the melt granules.

17. Melt granules for detergents or cleaning agents prepared by the method of claim 1, in the form of wafers or rods having a geometric length:width:thickness ratio in the range of 1:0.1-1:<0.1-0.005.

18. Melt granules for detergents or cleaning agents prepared by the method of claim 1, in the form of cubes, cuboids, trapezoids, rings, tubes, cones, cylinders, or stars.

19. Melt granules for detergents or cleaning agents prepared by the method of claim 1, in the form of beads with an average shape factor of >0.84.

20. The melt granules of claim 19, having an average shape factor of >0.86.
